(19) United States
(12) Patent Application Publication
(10) Pub. No.: US 2017/0221048 A1
(43) Pub. Date: Aug. 3, 2017

(54) Contactless Principal and Mini-Dependent Credit Cards

(71) Applicant: Aliasghar Babajafari, Grande Prairie (CA)

(72) Inventor: Aliasghar Babajafari, Grande Prairie (CA)

(21) Appl. No.: 15/009,797

(22) Filed: Jan. 28, 2016

(51) Int. Cl. G06Q 20/34; G07F 7/08

(52) U.S. Cl. CPC G06Q 20/3572; G07F 7/0893

(57) ABSTRACT

Using credit cards could be challenging when dealing with too many of them. We have a solution to use smaller credit cards link with a principal card. Mini-Dependent cards have limited amount of credit to help make using credits cards much simpler. The idea is to have a main credit card assigned to the head of an association and/or family. The principle can control the credit that is on a mini dependent and allows the individual to use limited credits from the principle without risking nearly as much as when a credit card gets lost or stolen. The amount of credits on a mini dependent can be set by the owner of Principle Credit Card. Example, a dependant credit card can be mounted inside fuel compartment of a vehicle for fueling, or can be mounted in a school student's wallet to facilitate using allowance.

I, Aliasghar Babajafari, have discovered new useful methods, designs, processes, developments, systems and ornamentals for Contactless Credit Cards as set forth in the following specification.

New useful system designs, processes, and developments of using existing credit cards' technologies to organize and facilitate transactions. In this method, we have Principal Credit Card as we call it “PRIN-CC” (Principal Credit Card) along with one to many dependent smaller size contactless credit cards, as we call them “MINI-CC” (Mini-Dependent Credit Cards), on the same or interrelated account. The credit on PRIN-CC can be used by itself and by its MINI-CC(s).

### FIGURES

FIG. 1—A main credit card, which is named “PRIN-CC” (Principal Credit Card).

FIG. 2—Anti-Vandal MINI-CC (Mini-Dependent Credit Card) for transaction including protected shield against theft contactless readers.

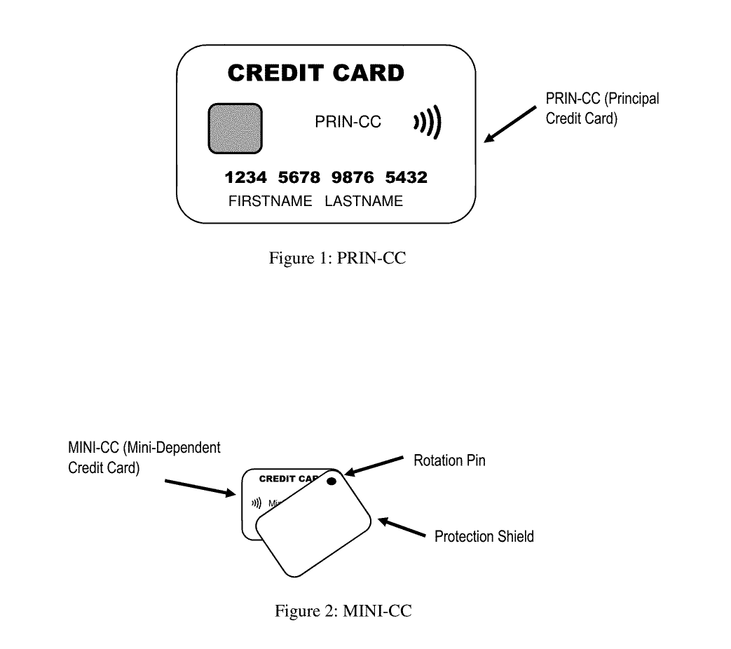

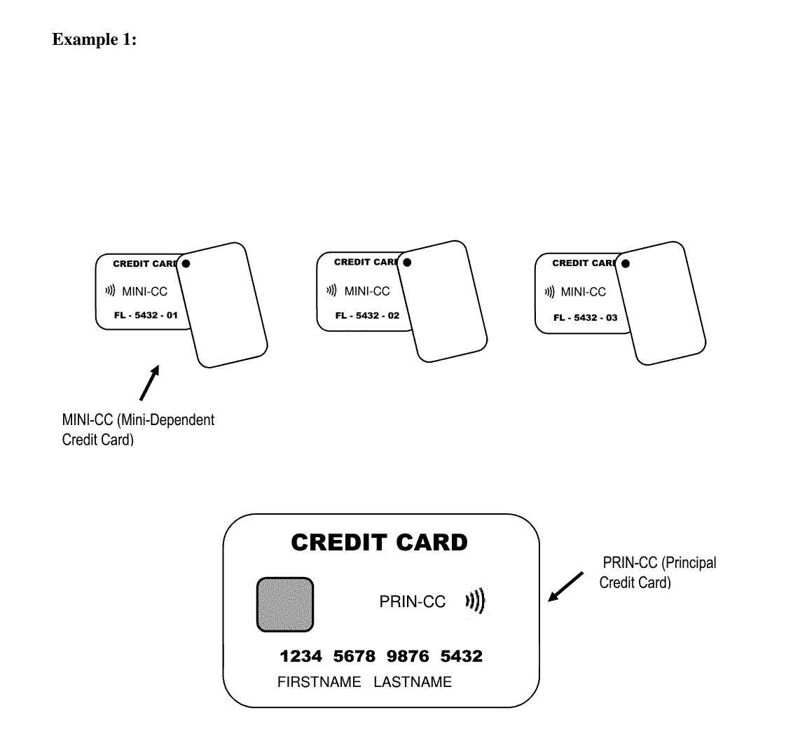

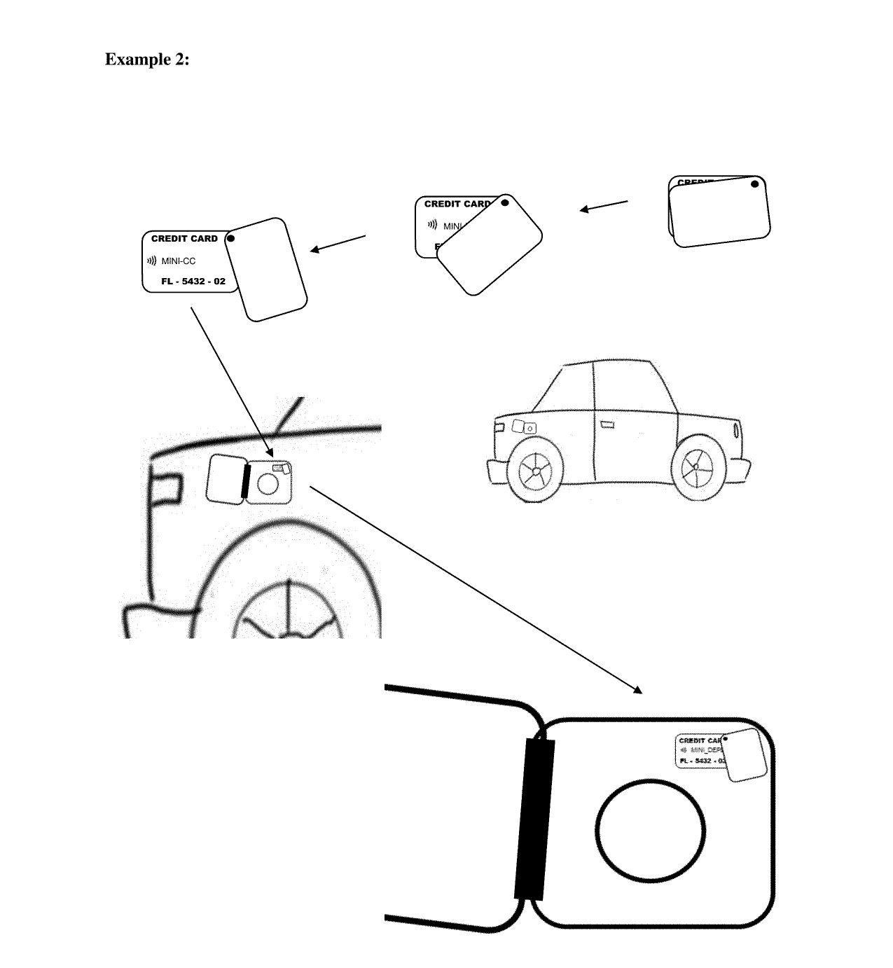

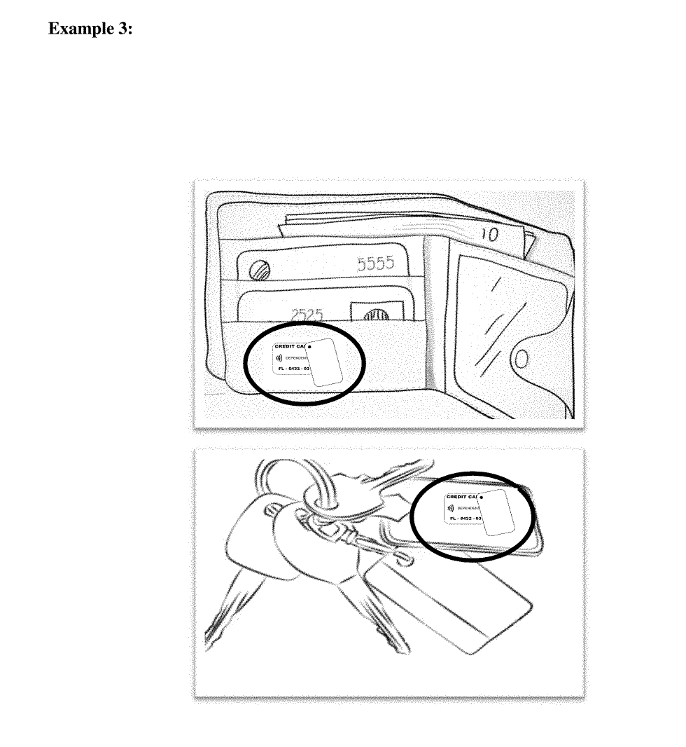

I claim: methods, designs, processes, developments, systems and ornamentals as have been described and shown.

### Applications By Examples

### EXAMPLE 1

A mother in a family can have a PRIN-CC (Principal Credit Card) for herself and three contactless MINI-CCs (Mini-Dependent Credit Cards) for her three children. Each MINI-CC is set or adjusted the amount by using username and password with the Credit Card company for her children.

### EXAMPLE 2

A company needs one PRIN-CC for a manager and 12 contactless MINI-CCs for their employees that they can just pay for their company's vehicles fueling. Each MINI-CC has $100 limit for each transaction with $1000 maximum monthly credit limit and can be fixed inside fuel compartments of a vehicle.

### System Specifications

This can be a method of using existing credit card technology and contactless card reader to identify and authorize fueling dispensing and payments. Customers of credit card companies can receive a PRIN-CC including anti-vandal MINI-CC(s) with protected shields to prevent theft's contactless readers specifically for fueling purposes. Anti-vandal MINI-CCs can be fixed in the fuel compartment of vehicles. This type of MINI-CCs should be void (damaged) systematically after removal. This system can be used for fueling vehicles, boats, airplanes, and etc.

MINI-CCs can be carried in different ways in wallet or key chain to facilitate fueling and payments as well.

The authorized pump station will have to provide accessible/portable reader close to the pumps. So, this method may need 3rd party installation of contactless readers on the dispensers' nozzles, or increase the distance of reading the chips, up to a couple of meters, in front of the dispensers to prevent the installation of readers on nozzles.

As per requirement, MINI-CCs can be differentiated for different categories of fuel or engines. For example:
MINI-CC for gasoline can be in green color and 2-digit even numbers at the end,
MINI-CC for diesel in yellow color and 2-digit odd numbers at the end,

A Regular Contactless Credit Card will be produced as PRIN-CC (Principal Credit Card) along with one to many Anti-vandal MINI-CC(s) (Mini-Dependent Credit Cards). For example, if a company has 30 vehicles, they can request one PRIN-CC with 30 MINI-CCs from 01 to 30, or they may request 3 PRINCCs with 3 sets of 10 MINI-CCs.

On all MINI-CCs, we need to have just the last four digits of the PRIN-CC plus 2-digit extension as MINI-CC number, and the initial of the owner's name for organization of multiple PRIN-CCs and their associated MINI-CCs.
PRIN-CC Number: 1234 5678 9876 5432
MINI-CC Number: 5432-01

The credit card company may apply different system of assigning accounts, initiating PRIN-CC numbers or managing extension numbering system for MINI-CCs. As an example:
PRIN-CC Number: 1234 5678 9876 5432
MINI-CC Number 01: 5432-01
MINI-CC Number 02: 5432-02
MINI-CC Number 03: 5432-03

### EXAMPLE 3

MINI-CCs can be fixed or carried in different means, and protection shields can be designed on opposite sides on the wallet too.

I claim:

1. utility (operability, beneficial utility, and practical utility), methods, designs, processes, developments, systems and ornamentals as have been described and shown.
I claim micro entity status.
